(19) United States
(12) Patent Application Publication
(10) Pub. No.: US 2014/0261996 A1
(43) Pub. Date: Sep. 18, 2014

(54) METHODS OF MANUFACTURING AN ARTICLE OF FOOTWEAR INCLUDING SINTERING A COPOLYMER POWDER

(71) Applicant: CROCS, INC., Niwot, CO (US)

(72) Inventors: Luca FAGGIN, Padova (IT); Stefano FERNIANI, Padova (IT)

(21) Appl. No.: 14/213,779

(22) Filed: Mar. 14, 2014

Related U.S. Application Data
(60) Provisional application No. 61/790,840, filed on Mar. 15, 2013.

(51) Int. Cl. B29D 35/14

(52) U.S. Cl. CPC B29D 35/142
USPC 156/245; 264/37.3

(57) ABSTRACT

A method of manufacturing an article of footwear includes providing a powder including a plurality of particles each comprising ethylene vinyl acetate, delivering the powder to a cavity of a mold, the mold being at an elevated temperature, pressing the powder in the cavity of the mold between the mold and a counter-mold, the counter-mold being at an elevated temperature, to fuse the particles of the powder and thereby provide a first portion of the article of footwear, removing the first portion of the article of footwear from the cavity of the mold, cooling the first portion of the article of footwear, providing a second portion of the article of footwear, and coupling the first portion of the article of footwear to the second portion of the article of footwear.

### CROSS-REFERENCE TO RELATED APPLICATION

This application claims the benefit of U.S. Provisional Patent Application Ser. No. 61/790,840, filed on Mar. 15, 2013, which is incorporated by reference herein in its entirety for all purposes.

### TECHNICAL FIELD

The present invention relates to methods of manufacturing an article of footwear. More specifically, the present invention relates to methods of manufacturing an article of footwear that includes sintering a copolymer powder to form one or more components of the article of footwear.

### BACKGROUND

Various types of articles of footwear include one or more components formed via injection molding processes to provide various advantageous characteristics. For example, many types of soles are formed via injection molding to facilitate relative comfort.

Unfortunately, components formed in such a manner also have various disadvantages. For example, forming footwear components via injection molding processes, like many injection molding processes, involves removing a significant amount of excess material from the components. In many cases, the excess material takes the form of molded features formed in passageways that deliver molten material to an injection molding cavity (commonly referred to as “sprues”, “runners”, and “gates”). This excess material significantly increases the cost associated with manufacturing these components and the associated articles of footwear.

As another example, it is typically difficult for injection molding processes to provide footwear components having appropriate mechanical characteristics, such as hardness or the like. Similarly, it is typically difficult for injection molding processes to provide features having intricate shapes, such as gripping features disposed on the lower surface of a sole.

### SUMMARY

A method of manufacturing an article of footwear according to some embodiments of the present invention includes collecting excess material from a manufacturing process after the excess material has undergone an injection molding process, wherein the excess material comprises ethylene vinyl acetate, processing the excess material to form powder, delivering the powder to a cavity of a mold, applying pressure to the powder in the cavity of the mold using a counter-mold, and heating the powder in the cavity of the mold to thereby, together with applying pressure to the powder using the counter-mold, fuse the particles of the powder and form a portion of the article of footwear.

A method of manufacturing an article of footwear according to some embodiments of the present invention includes providing a powder including a plurality of particles each comprising ethylene vinyl acetate, delivering the powder to a cavity of a mold, the mold being at an elevated temperature, pressing the powder in the cavity of the mold between the mold and a counter-mold, the counter-mold being at an elevated temperature, to fuse the particles of the powder and thereby provide a first portion of the article of footwear, removing the first portion of the article of footwear from the cavity of the mold, cooling the first portion of the article of footwear, providing a second portion of the article of footwear, and coupling the first portion of the article of footwear to the second portion of the article of footwear.

A method of manufacturing an article of footwear according to some embodiments of the present invention includes providing a powder including a plurality of particles each comprising ethylene vinyl acetate, delivering the powder to a cavity of a mold, applying pressure to the powder in the cavity of the mold using a counter-mold, heating the powder in the cavity of the mold to thereby, together with applying pressure to the powder using the counter-mold, fuse the particles of the powder and form a first portion of the article of footwear, removing the first portion of the article of footwear from the cavity of the mold, cooling the first portion of the article of footwear, providing a second portion of the article of footwear, and coupling the first portion of the article of footwear to the second portion of the article of footwear.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates an exemplary method of manufacturing an article of footwear according to embodiments of the present invention;

FIG. 2 illustrates a partial perspective view of an exemplary article of footwear manufactured according to the method of FIG. 1;

FIG. 3 illustrates a copolymer powder used by the method of FIG. 1;

FIG. 4 illustrates a partial perspective view of an elevated temperature mold used by the method of FIG. 1;

FIG. 5 illustrates a partial side sectional view of the mold along line 5-5 of FIG. 4;

FIG. 6 illustrates a partial side sectional view of the mold along line 5-5 of FIG. 4 receiving the copolymer powder of FIG. 3;

FIG. 7 illustrates a perspective view of an elevated temperature counter-mold used by the method of FIG. 1;

FIG. 8 illustrates a bottom view of the counter-mold of FIG. 7;

FIG. 9 illustrates a partial side sectional view of the mold of FIG. 4 receiving the powder of FIG. 3, and the powder being pressed by the counter-mold of FIG. 7;

FIG. 10 illustrates a bottom view of an outsole formed by the method of FIG. 1;

FIG. 11 illustrates a partial perspective view of the outsole of FIG. 10;

FIG. 12 illustrates a partial side sectional view of the outsole along line 12-12 of FIG. 10;

FIG. 13 illustrates a bottom view of the outsole of FIG. 10 connected to another portion of the sole of the article of footwear;

FIG. 14 illustrates another exemplary method of manufacturing an article of footwear according to embodiments of the present invention;

FIG. 15 illustrates a partial perspective view of an elevated temperature mold used by the method of FIG. 14;

FIG. 16 illustrates a partial side sectional view of the mold along line 16-16 of FIG. 14 receiving a copolymer powder;

FIG. 17 illustrates a partial side sectional view of the mold of FIG. 15 receiving the powder, and the powder being pressed by a counter-mold;

FIG. 18 illustrates a top view of a panel or sheet formed by the method of FIG. 14;

FIG. 19 illustrates a partial side sectional view of the sheet along line 19-19 of FIG. 18;

FIG. 20 illustrates a top view of the panel of FIG. 18 being cut to provide an outer layer of an upper; and

FIG. 21 illustrates a top view of an inner layer of the upper to be connected to the outer layer of FIG. 20.

### DETAILED DESCRIPTION

FIG. 1 illustrates an exemplary method of manufacturing the article of footwear 200 shown in FIG. 2. The article of footwear 200 may be, for example, a casual shoe as shown in FIG. 2, a running shoe, a golf shoe, a walking shoe, a tennis shoe, a molded shoe, a shoe with cleats, a shoe without cleats, a hiking boot, a ski boot, a roller skate shoe, a roller blade shoe, an ice skating shoe, a sandal, or any other kind of shoe or footwear. Generally, the method illustrated in FIG. 1 includes sintering a powder to form a portion of the article of footwear 200. In some embodiments, the sintered portion of the article of footwear 200 may be, for example, a portion of the sole 202, specifically a portion of the outsole 204. The exemplary method illustrated in FIG. 1 is described as forming an article of footwear 200 including a sintered outsole 204. It is to be understood, however, that in some embodiments the sintered portion may be another portion of the article of footwear 200.

The method begins at block 100 by obtaining powder 300 (see FIG. 3) that includes a plurality of individual particles 302. The particles 302 comprise one or more materials, for example, a copolymer resin foam, particularly ethylene vinyl acetate (EVA). A powder including a plurality of particles in which each of the plurality of particles comprises EVA may also be intermixed with other particles which do not comprise EVA or which are not primarily EVA. For example, a plurality of particles in which each of the particles comprises EVA may be intermixed with other particles that are contaminants or other products, but such other products may be of a concentration that is small enough so as to not affect the outcome of the processes described herein. In some embodiments, the particles 302 may be between about 40 mesh to 50 mesh (that is, the particles 302 are sufficiently small to pass through a screen or sieve having a mesh size of about 40 and sufficiently large to be retained by a screen or sieve having a mesh size of about 50).

The powder 300 may be formed using recycled materials obtained in various manners. In some embodiments, the powder 300 is obtained by first separating excess material (or production “scraps”) from footwear components (for example, clogs, soles, or the like) formed by one or more different manufacturing processes, such as injection molding and the like. In this case, the excess material may be molded features formed in passageways that deliver molten material to an injection molding cavity. These excess injection molding features are commonly referred to as “sprues”, “runners”, and “gates”. The excess material may be processed in various manners, such as grinding, cutting, and the like, to form the powder 300.

In some embodiments, the powder 300 is obtained by first receiving excess material produced during manufacture of other types of products including one or more copolymers, such as footwear, furniture, and the like. The other types of products may be formed by one or more different manufacturing processes, such as injection molding and the like. In this case, the excess material may take the form of sprues, runners, and gates as described above. The excess material may be received from other manufacturing lines of the same facility that performs the present methods or other facilities, such as other manufacturing locations of the same corporation, manufacturing locations of one or more different corporations, combinations thereof, and the like. For example, in the manufacture of molded foam footwear from EVA, for example molded clogs having an upper and a sole that are integrally injection molded in EVA, excess EVA material is produced. Normally, only a small portion of such excess material may be recycled or reused in the manufacturing process; for example, in some cases the manufacturing tolerances and quality control parameters may dictate that only 5% by volume of recycled EVA material may be mixed into the stream of new EVA raw material entering the molds. Methods according to embodiments of the present invention permit, for example, one hundred percent of the excess material to be used, though in a different process (sintering) to form a different type of final article. The excess material may be processed in various manners, such as grinding, cutting, and the like, to form the powder 300.

In some embodiments, the powder 300 is obtained by first receiving returned products, such as articles of footwear. The products may be, for example, excess inventory returned by a distributor, undesired or defective products returned by an end user, defective products returned by an internal quality control department, used products returned in a recycling program (that is, returning used products upon purchasing a new product), combinations thereof, or the like. Portions of the products that include appropriate copolymer materials, such as the soles, are separated from other portions and may be subjected to intermediate processing steps, such as washing, cleaning, or the like. The portions that include the appropriate copolymer materials may be processed in various manners, such as grinding, cutting, and the like, to form the powder 300.

The method continues at block 102 by delivering the powder 300 to a cavity 402 of a mold 400 (shown separately in FIGS. 4 and 5 and shown with the powder 300 in FIG. 6). The mold 400 includes a plurality of surfaces that define the cavity 402 and together form, in part, the inverse shape of the outsole 204. The surfaces include side surfaces 404 that together define a perimeter shape of the outsole 204. For example and as shown in FIGS. 4 and 5, the side surfaces 404 may provide a rain drop-like perimeter shape. In some embodiments, the side surfaces 404 may provide various other types of perimeter shapes. In some embodiments, the side surfaces 404 provide a draft angle of at least two degrees to facilitate removal of the outsole 204 from the cavity 402 after sintering.

The plurality of surfaces also includes a lower surface 406 that defines a lower surface of the outsole 204. In some embodiments, the lower surface 406 of the mold 400 may include a plurality of features that provide the outsole 204 with the inverse features. On the outsole 204, such features may serve functional purposes (for example, to provide improved traction) and/or aesthetic purposes. For example and as shown in FIGS. 4 and 5, the lower surface 406 includes a plurality of “zig-zag”-shaped grooves or channels 408 disposed between a plurality of zig-zag-shaped protrusions or ridges 410. The lower surface 406 further includes two linearly-extending protrusions or ridges 412 that together define an “X” shape. In some embodiments, the lower surface 406 of the mold 400 may include various other shapes and/or types of features.

In some embodiments, the plurality of features defined by the lower surface 406 of the mold 400 may have a height of up to 30 percent of a desired nominal thickness (or height) of the outsole 204. In some embodiments, the plurality of features defined by the lower surface 406 of the mold 400 may have a height of up to 50 percent of the desired nominal thickness or height of the outsole 204.

The mold 400 is at an elevated temperature relative to its environment and the powder 300. The elevated temperature may be facilitated by a heating system (not shown) coupled to the mold 400, such as a system including resistive heating elements that extend through or are coupled to the mold 400. In some embodiments, the elevated temperature is less than the melting temperature of the copolymer material but sufficiently high to cause, when pressure is applied to the powder 300 for a certain time period, atomic diffusion within the powder 300. This action fuses the particles 302 and forms single-piece component (that is, the powder 300 is sintered). In some embodiments, the elevated temperature is between about 170 and 180 degrees Celsius.

In some embodiments, the volume of the powder 300 that is delivered to the cavity 402 of the mold 400 depends on the desired volume of the outsole 204, the desired density of the outsole 204, and the density of the powder 300. In some embodiments, the volume of the powder 300 that is delivered to the cavity 402 is determined according to the following equation:

V₀=(D₁/D₀)·V₁

where

V₀ is the volume of the powder 300 that is delivered to the cavity 402;

D₀ is the density of the powder 300;

V₁ is the desired volume of the outsole 204; and

D₁ is the desired density of the outsole 204.

As an example, the density of the powder 300 may be 0.25 g/cm³ and the desired density of the outsole 204 may be 0.66 g/cm³. Thus, the above equation takes the following form:

V₀=2.64·V₁

In some embodiments, the density of the powder 300 and the desired density of the outsole 204 may vary. For example, the density of the powder 300 may vary depending on multiple factors, such as the size of the particles 302 or the like.

At block 104 and as shown in FIG. 6, the method continues by uniformly distributing the powder 300 in the cavity 402 by using, for example, a blade (not shown). That is, the powder 300 is uniformly distributed to ensure that all portions of an upper surface 602 of the powder 300 are disposed at substantially the same elevation.

The method continues at block 106 by pressing the powder 300 in the mold cavity 402 with a counter-mold 700 (shown separately in FIGS. 7 and 8 and shown with the mold 400 and powder 300 in FIG. 9). The counter-mold 700 includes a lower surface 702 that applies pressure to the powder 300 in the mold cavity 402. The lower surface 702 is substantially flat and parallel relative to the lower surface 406 of the mold cavity 402. This provides the outsole 204 with a substantially uniform thickness (besides any features formed by the lower surface 406 of the mold cavity 402, such as those formed by the channels 408 and ridges 410).

In some embodiments, the counter-mold 700 further includes vent passageways (not shown) disposed proximate the edges of the counter-mold 700. The vent passageways receive air that was previously disposed between the particles 302 of the powder 300 when the powder 300 is pressed by the counter-mold 700. As such, the vent passageways facilitate compacting the powder 300 and displacing the individual particles 302 toward each other. In some embodiments, the vent passageways extend through the lower surface 702 of the counter-mold 700 and vertically through the counter-mold 700.

The counter-mold 700 further includes side surfaces 706 that may have substantially the same draft angle as the side surfaces 404 of the mold cavity 402 (for example, at least two degrees). The side surfaces 706 are spaced apart from the side surfaces 404 of the mold cavity 402 to facilitate formation of side walls on the outsole 204. These side walls are explained in further detail below.

The counter-mold 700 is at an elevated temperature relative to the environment and the powder 300. The elevated temperature may be facilitated by a heating system (not shown) coupled to the counter-mold 700, such as a system including resistive heating elements that extend through or are coupled to the counter-mold 700. In some embodiments, the elevated temperature of the counter-mold 700 is substantially the same as the elevated temperature of the mold 400. That is, the elevated temperature of the counter-mold 700 is less than the melting temperature of the copolymer material but sufficiently high to sinter the powder 300. In some embodiments, the elevated temperature is between about 170 and 180 degrees Celsius.

The method continues at block 108 by sintering the powder 300 in the mold cavity 402 for a predetermined time period. That is, the counter-mold 700 maintains pressure on the powder 300 in the mold cavity 402 for the predetermined time period. The mold 400 and the counter-mold 700 also heat the powder 300 in the mold cavity 402 via, for example, conductive heat transfer, during the predetermined time period. In some embodiments, the predetermined time period is between about three minutes and five minutes depending on, for example, the dimensions of the outsole 204. In some embodiments, the force applied to the powder 300 by the counter-mold 700 is about 200 tons.

After expiration of the predetermined time period and at block 110, the counter-mold 700 disengages the outsole 204 and the mold 400. At block 112, the outsole 204 is removed from the mold cavity 402 and transported to a cooling location (not shown) apart from the mold 400 and counter-mold 700. The cooling location may take various forms. For example, in some embodiments the cooling location may be the surface of a table that facilitates free convective heat transfer from the heated outsole 204 to the environment.

The above actions may provide, for example, the outsole 204 illustrated in FIGS. 10-12. The outsole 204 includes a main body 1202 (see FIG. 12) having an upper surface 1204 formed by the lower surface 702 of the counter-mold 700. The upper surface 1204 is substantially flat, although it may include small protrusions (not shown) formed by the vent passageways in the counter-mold 700.

The main body 1202 also includes a ground-engaging lower surface 1006 formed by the lower surface 406 of the mold 400. In some embodiments, the lower surface 1006 of the outsole 204 includes features that may serve functional purposes (for example, to provide improved traction) and/or aesthetic purposes. For example, the lower surface 1006 may include a plurality of plurality of zig-zag-shaped grooves or channels 1008 disposed between a plurality of zig-zag-shaped protrusions or ridges 1010 formed by the inverse features of the lower surface 406 of the mold 400 (that is, the protrusions 410 and grooves 408, respectively). In some embodiments, the lower surface 1006 of the outsole 204 includes two linearly-extending grooves or channels 1012 formed by the linearly-extending protrusions 412 of the lower surface 406 of the mold 400. The linearly-extending grooves or channels 1012 together define an “X” shape.

The thickness of the main body 1202 may be uniform to facilitate uniform mechanical properties for the outsole 204. In some embodiments including the grooves 1008 and 1012 and the protrusions 1010, the main body 1202 may be considered to have a uniform thickness if the thickness at all locations on the main body 1202 is within 50 percent of a nominal thickness. In other embodiments including the grooves 1008 and 1012 and the protrusions 1010, the main body 1202 may be considered to have a uniform thickness if the thickness at all locations on the main body 1202 is within 30 percent of a nominal thickness. In some embodiments, the main body 1202 has a nominal thickness of 6 mm, 4 mm, or 1.5 mm.

The outsole 204 further includes side walls 1214 (see FIG. 12) formed in the gap between the side surfaces 404 and 706 of the mold 400 and counter-mold 700. The side walls 1214 extend upwardly from the perimeter of the main body 1202. The side walls 1214 also extend outwardly (that is, horizontally) from the perimeter of the main body 1202 due to the draft angle of the side surfaces 404 and 706 of the mold 400 and counter-mold 700. In some embodiments, the side walls 1214 may have a height of at most 50 percent of the nominal thickness of the main body 1202.

The outsole 204 may have mechanical properties similar to those of outsoles manufactured using other methods. In some embodiments, the outsole 204 may have a durometer hardness (determined using the ASTM 2240 testing method) of about 82 Asker C, a resilience rebound (ASTM 2632) of about 46 percent, a tensile strength (ASTM D412) of about 60.8 kg/cm², an elongation (ASTM D412) of about 514 percent, an abrasion resistance (DIN 53516) of about 154 mm³, and a specific gravity (ASTM D792 B) of about 0.93 g/cm³.

At block 114, another portion of the article of footwear 200 is provided. The other portion of the article of footwear 200 may be, for example, the upper 206 of the article of footwear 200, another portion of the sole 202, such as another portion of the outsole 208 (see FIG. 2) or the midsole (not shown), or the like. The other portion of the article of footwear 200 may be manufactured in various manners. For example and as described in further detail below, if the other portion of the article of footwear 200 is the upper 206, it may be manufactured in a similar manner as the outsole 204. As another example, if the other portion of the article of footwear 200 is another portion of the sole 202, it may be manufactured in an injection molding process. Specifically, the other portion of the sole 202 may be manufactured in the manner described in U.S. Pat. No. 6,439,536, the disclosure of which is hereby incorporated by reference.

At block 116 and as shown in FIG. 13, the outsole 204 is connected to the other portion of the article of footwear 200. For example, if the other portion of the article of footwear 200 is another portion of the sole 202, it may be adhered to the outsole 204. At block 118, further portions of the article of footwear 200 are provided and connected, such as the upper 206, laces (not shown), and the like, to form the completed article of footwear 200 (see FIG. 2).

FIG. 14 illustrates another exemplary method of manufacturing an article of footwear. Like the above method, this method generally includes sintering a powder to form a portion of the article of footwear. In some embodiments, the sintered portion of the article of footwear may be, for example, a layer of the upper 206 (see FIG. 2), specifically an outer layer 210 of the upper 206. The exemplary method illustrated in FIG. 14 is described as forming an article of footwear including a sintered outer layer 210 of the upper 206. It is to be understood, however, that in some embodiments the sintered portion may be another portion of the article of footwear.

The method begins at block 1400 by obtaining a copolymer powder, which may be as described above. The powder may be obtained in one or more of the manners described above.

The method continues at block 1402 by delivering the powder to a cavity 1502 of a mold 1500 (shown separately in FIG. 15 and shown with the powder 1600 in FIG. 16). The mold cavity 1502 includes side surfaces 1504 that together define a substantially rectangular perimeter shape. In some embodiments, the side surfaces 1504 provide a draft angle of at least two degrees to permit removal of the outer layer 210 of the upper 206 from the cavity 1502 after sintering. The mold cavity 1502 further includes a lower surface 1506 that defines the outer surface of the outer layer 210 of the upper 206. In some embodiments and as shown in the figures, the lower surface 1506 of the mold cavity 1502 is substantially flat.

The mold 1500 is at an elevated temperature relative to its environment and the powder 1600. The elevated temperature may be facilitated by a heating system (not shown) coupled to the mold 1500, such as a system including resistive heating elements that extend through or are coupled to the mold 1500. The elevated temperature is sufficiently high, when pressure is applied to the powder 1600 for a certain time period, to sinter the powder 1600. In some embodiments, the elevated temperature is between about 170 and 180 degrees Celsius.

In some embodiments, the volume of the powder that is delivered to the cavity 1502 of the mold 1500 depends on the desired volume of the outer layer 210 of the upper 206, the desired density of the outer layer 210 of the upper 206, and the density of the powder. In some embodiments, the volume of the powder that is delivered to the cavity 1502 is determined according to the following equation:

V₀=(D₁/D₀)·V₁

where

V₀ is the volume of the powder that is delivered to the cavity 1502;

D₀ is the density of the powder;

V₁ is the desired volume of the outer layer 210 of the upper 206; and

D₁ is the desired density of the outer layer 210 of the upper 206.

As an example, the density of the powder may be 0.25 g/cm³ and the desired density of the outer layer 210 of the upper 206 may be 0.66 g/cm³. Thus, the above equation takes the following form:

V₀=2.64·V₁

In some embodiments, the density of the powder and the desired density of the outer layer 210 of the upper 206 may vary. For example, the density of the powder may vary depending on multiple factors, such as the size of the particles of the powder or the like.

At block 1404 and as shown in FIG. 16, the method continues by uniformly distributing the powder 1600 in the cavity 1502 by using, for example, a blade (not shown). That is, the powder 1600 is uniformly distributed to ensure that all portions of an upper surface 1602 of the powder 1600 are disposed at substantially the same elevation.

The method continues at block 1406 by pressing the powder 1600 in the mold cavity 1502 with a counter-mold 1700 (shown with the mold 1500 and powder 1600 in FIG. 17). The counter-mold 1700 includes a lower surface 1702 that applies pressure to the powder 1600 in the mold cavity 1502. The lower surface 1702 is substantially flat and parallel relative to the lower surface 1506 of the mold cavity 1502. This provides the sintered component with a substantially uniform thickness.

The counter-mold 1700 further includes vent passageways (not shown) disposed proximate the edges of the counter-mold 1700. The vent passageways receive air previously disposed between the particles of the powder 1600 when the powder 1600 is pressed by the counter-mold 1700. As such, the vent passageways facilitate compacting the powder 1600 and displacing the individual particles toward each other. In some embodiments, the vent passageways extend through the lower surface 1702 of the counter-mold 1700 and vertically through the counter-mold 1700.

The counter-mold 1700 further includes side surfaces 1706 that may have substantially the same draft angle as the side surfaces 1504 of the mold cavity 1502 (for example, at least two degrees). The side surfaces 1706 are spaced apart from the side surfaces 1504 of the mold cavity 1502 to facilitate formation of side walls on the sintered component.

The counter-mold 1700 is at an elevated temperature relative to the environment and the powder 1600. The elevated temperature may be facilitated by a heating system (not shown) as described above. The elevated temperature is sufficiently high, when the counter-mold 1700 applies pressure to the powder 1600 for a certain time period, to sinter the powder 1600. In some embodiments, the elevated temperature is between about 170 and 180 degrees Celsius.

The method continues at block 1408 by sintering the powder 1600 in the mold cavity 1502 for a predetermined time period. That is, the counter-mold 1700 maintains pressure on the powder 1600 in the mold cavity 1502 for the predetermined time period. The mold 1500 and the counter-mold 1700 also heat the powder 1600 in the mold cavity 1502 via, for example, conductive heat transfer, during the predetermined time period. In some embodiments, the predetermined time period is between about three minutes and five minutes depending on, for example, the desired thickness of the outer layer 210 of the upper 206. In some embodiments, the force applied to the powder 300 by the counter-mold 1700 is about 200 tons.

After expiration of the predetermined time period and at block 1410, the counter-mold 1700 disengages the outer layer 210 of the upper 206 and the mold 1500. At block 1412, the outer layer 210 of the upper 206 is removed from the mold cavity 1502 and transported to a cooling location (not shown) apart from the mold 1500 and counter-mold 1700. The cooling location may take various forms. For example, in some embodiments the cooling location may be the surface of a table that facilitates free convective heat transfer from the outer layer 210 to the environment.

The above actions may provide, for example, the outer layer 210 of the upper 206 in the intermediate form of a panel or sheet 1800 as illustrated in FIGS. 18 and 19. The sheet 1800 includes a main body 1802 having an upper surface 1804 that is formed by the lower surface 1702 of the counter-mold 1700. The upper surface 1804 may be substantially flat, although it may include small protrusions (not shown) formed by the vent passageways in the counter-mold 1700. The main body 1802 also includes a lower surface 1906 (see FIG. 19) formed by the lower surface 1506 of the mold 1500. The lower surface 1906 may be substantially flat. The thickness of the main body 1802 may be uniform to facilitate uniform mechanical properties for the outer layer 210 of the upper 206. In some embodiments, the main body 1802 has a nominal thickness of 6 mm, 4 mm, or 1.5 mm.

The sheet 1800 further includes side walls 1814 formed in the gap between the side surfaces 1504 and 1706 of the mold 1500 and counter-mold 1700. The side walls 1814 extend upwardly from the perimeter of the main body 1802. The side walls 1814 also extend outwardly (that is, horizontally) from the perimeter of the main body 1802 due to the draft angle of the side surfaces 1504 and 1706 of the mold 1500 and counter-mold 1700. In some embodiments, the side walls 1814 may have a height of at most 50 percent of a nominal thickness of the main body 1802.

At block 1414 and as shown in FIG. 20, the sheet 1800 is cut, for example, using a knife (not shown) or the like, to form an appropriately-shaped outer layer 210 of the upper 206. In some embodiments, the sheet 1800 is cut such that the outer layer 210 of the upper 206 does not include portions of the side walls 1814. At block 1416, a remainder 2002 of the sheet 1800 is separated from the outer layer 210 of the upper 206. The remainder 2002 of the sheet 1800 may be processed to form the powder described above.

At block 1418 and as shown in FIG. 21, another portion of the article of footwear is provided. The other portion of the article of footwear may be, for example, an inner layer 2100 of the upper 206. The other portion of the article of footwear may be manufactured in various manners. For example, if the other portion of the article of footwear is an inner layer 2100 of the upper 206, it may be manufactured by cutting a fabric sheet (not shown) or the like.

At block 1420, the outer layer 210 of the upper 206 is connected to the other portion of the article of footwear. For example, if the other portion of the article of footwear is an inner layer 2100 of the upper 206, it may be adhered to the outer layer 210. At block 1422, further portions of the article of footwear are provided and connected, such as laces (not shown), the sole, and the like, to form the completed article of footwear.

In some embodiments and as briefly described above, the above methods may be combined to provide an article of footwear that includes both a sintered outsole and a sintered upper. Similarly, in some embodiments the article of footwear includes different combinations of sintered components. For example, methods according to some embodiments of the present invention may create multiple sintered outsole portions, each having different lower surface features, colors, and the like, that together form an article of footwear.

In some embodiments, the powder may be provided to and uniformly distributed in the mold cavity in other manners. For example, the powder may be delivered to and uniformly distributed in the mold cavity in a melted form via the injector of an injection molding machine (not shown). The mold and the counter mold may then sinter the material as described above.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A method of manufacturing an article of footwear, comprising:
providing a powder including a plurality of particles each comprising ethylene vinyl acetate;
delivering the powder to a cavity of a mold, the mold being at a first elevated temperature;
pressing the powder in the cavity of the mold between the mold and a counter-mold, the counter-mold being at a second elevated temperature, to fuse the particles of the powder and thereby provide a first portion of the article of footwear;
removing the first portion of the article of footwear from the cavity of the mold;
cooling the first portion of the article of footwear;
providing a second portion of the article of footwear; and
coupling the first portion of the article of footwear to the second portion of the article of footwear.

2. The method of claim 1, wherein pressing the powder in the cavity of the mold with the counter-mold includes maintaining pressure on the powder for a predetermined time period.

3. The method of claim 2, wherein the predetermined time period is in a range of between about three minutes and five minutes.

4. The method of claim 1, wherein the first portion of the article of footwear is adhered to the second portion of the article of footwear.

5. The method of claim 1, wherein the first portion of the article of footwear is a portion of an outsole and the second portion of the article of footwear is another portion of the outsole.

6. The method of claim 5, wherein the outsole includes a lower surface configured to engage the ground and having a plurality of protrusions.

7. The method of claim 1, wherein the first portion of the article of footwear is an outer layer of an upper and the second portion of the article of footwear is an inner layer of the upper.

8. The method of claim 1, wherein the elevated temperature of the mold and the elevated temperature of the counter-mold are both less than the melting temperature of ethylene vinyl acetate.

9. The method of claim 1, further comprising:
determining a desired volume of the first portion of the article of footwear;
determining a desired density of the first portion of the article of footwear;
and wherein delivering the powder to the cavity of the mold includes delivering a volume of the powder to the cavity according to the equation:
V₀=(D₁/D₀)·V₁
where
V₀ is the volume of the powder delivered to the cavity;
D₀ is the density of the powder delivered to the cavity;
V₁ is the desired volume of the first portion of the article of footwear; and
D₁ is the desired density of the first portion of the article of footwear.

10. The method of claim 1, wherein the particles of the powder are between about 40 mesh to 50 mesh.

11. The method of claim 1, wherein cooling the first portion of the article of footwear includes cooling the first portion of the article of footwear at a location other than the cavity of the mold.

12. The method of claim 1, further comprising cutting the first portion of the article of footwear to provide a layer of an upper of the article of footwear.

13. The method of claim 1, wherein providing the second portion of the article of footwear includes:
providing a second powder including a plurality of particles each comprising ethylene vinyl acetate;
delivering the second powder to a cavity of a second mold, the second mold being at an elevated temperature;
pressing the second powder in the cavity of the second mold between the second mold and a second counter-mold, the second counter-mold being at an elevated temperature, to fuse the particles of the second powder and thereby form the second portion of the article of footwear;
removing the second portion of the article of footwear from the cavity of the second mold; and
cooling the second portion of the article of footwear.

14. The method of claim 13, wherein the first portion of the article of footwear is an outsole and the second portion of the article of footwear is an upper.

15. The method of claim 1, wherein providing the powder includes:
collecting excess ethylene vinyl acetate material from another component manufacturing process; and
processing the excess ethylene vinyl acetate material to form the powder.

16. A method of manufacturing an article of footwear, comprising:
providing a powder including a plurality of particles each comprising ethylene vinyl acetate;
delivering the powder to a cavity of a mold;
applying pressure to the powder in the cavity of the mold using a counter-mold;
heating the powder in the cavity of the mold to thereby, together with applying pressure to the powder using the counter-mold, fuse the particles of the powder and form a first portion of the article of footwear;
removing the first portion of the article of footwear from the cavity of the mold;
cooling the first portion of the article of footwear;
providing a second portion of the article of footwear; and
coupling the first portion of the article of footwear to the second portion of the article of footwear.

17. The method of claim 17, wherein applying pressure to the powder in the cavity of the mold using the counter-mold includes maintaining pressure on the powder for a predetermined time period.

18. The method of claim 17, further comprising:
determining a desired volume of the first portion of the article of footwear;
determining a desired density of the first portion of the article of footwear;
and wherein delivering the powder to the cavity of the mold includes delivering a volume of the powder to the cavity according to the equation:
V₀=(D₁/D₀)·V₁
where
V₀ is the volume of the powder delivered to the cavity;
D₀ is the density of the powder delivered to the cavity;
V₁ is the desired volume of the first portion of the article of footwear; and
D₁ is the desired density of the first portion of the article of footwear.

19. A method of manufacturing an article of footwear, comprising:
collecting excess material from a manufacturing process after the excess material has undergone an injection molding process, wherein the excess material comprises ethylene vinyl acetate;
processing the excess material to form powder;
delivering the powder to a cavity of a mold;
applying pressure to the powder in the cavity of the mold using a counter-mold; and
heating the powder in the cavity of the mold to thereby, together with applying pressure to the powder using the counter-mold, fuse the particles of the powder and form a portion of the article of footwear.

20. The method of claim 19, further comprising:
removing the portion of the article of footwear from the cavity of the mold; and
incorporating the portion of the article of footwear into the article of footwear.
